(19) United States
(12) Patent Application Publication
(10) Pub. No.: US 2008/0031147 A1
(43) Pub. Date: Feb. 7, 2008

(54) Network status determination

(75) Inventors: Geert Fieremans, Boca Raton, FL (US); Rodrigo Pastro, Lake Worth, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/497,070

(22) Filed: Aug. 1, 2006

(51) Int. Cl. H04J 1/16

(52) U.S. Cl. 370/252; 370/217

(57) ABSTRACT

In the event of a non-responsive endpoint, a system can determine network health by querying a network agent located on the same subnet or branch of the network. If a response is received from the network agent, a device failure or absence may be assumed. If no response is received from the network agent, a network failure may be assumed. Statistical reliability may be enhanced by positioning more than one network agent on a subnet.

### BACKGROUND OF THE INVENTION

The invention described and claimed here concerns networks utilizing protocols such as the Session Internet Protocol (SIP), discussed in Requests for Comments nos. 3261-65 of the Internet Engineering Task Force, incorporated here by reference. These documents may be found at www.ietf.org.

### BRIEF DESCRIPTION OF THE DRAWINGS

FIG. 1 is a block diagram of a network of a telecommunications system;

FIGS. 2 and 5 are tables of network status; and

FIGS. 3 and 4 are call flow diagrams for querying a network agent.

### DESCRIPTION OF THE INVENTION

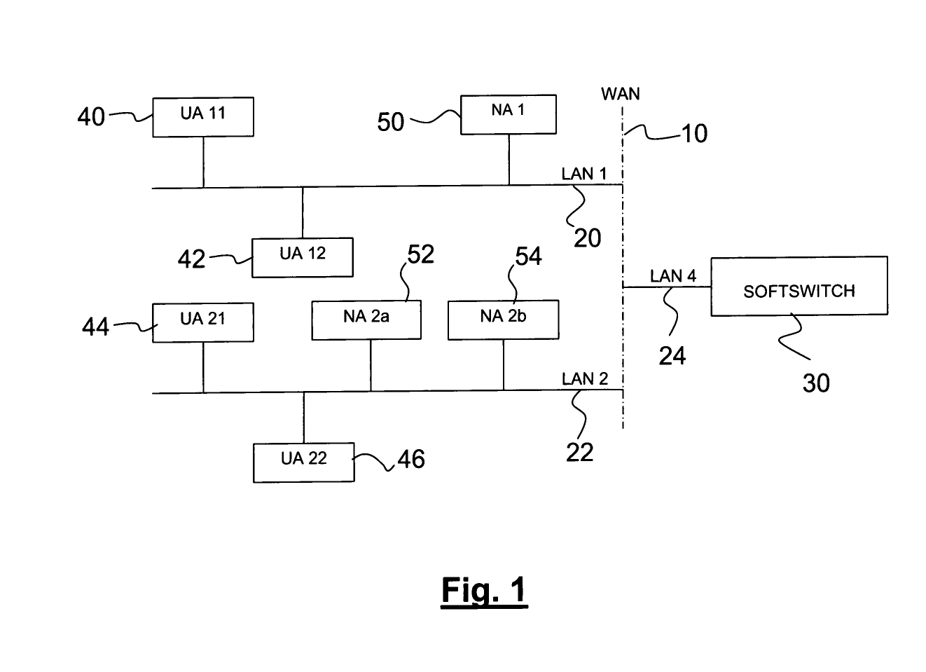

The telecommunications system illustrated in FIG. 1 has a wide area network (WAN) 10 interconnecting various local area networks (LAN) 20, 22, and 24. A network controller such as a softswitch 30 accesses the WAN via LAN 4. The system also hosts one or more endpoints such as SIP user agents 40, 42, 44, and 46 positioned on other LANs (LAN 1 and LAN 2 in this example).

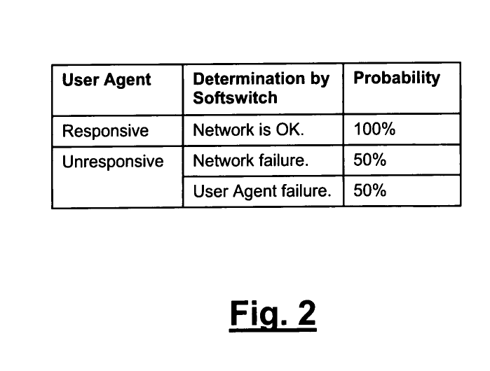

On occasion, a user agent may not be reachable by the softswitch 30. This may be detected as a timeout of the registration of an endpoint in the softswitch 30 or a registrar. In such a case, the network needs to determine whether the user agent has failed or is otherwise unavailable, or whether the LAN, the network, or subnet on which the user agent is located has failed. The chart in FIG. 2 sets forth the two possibilities, arbitrarily assigning a 50% probability of failure to each.

A network agent (NA) 50 can be used to determine whether there is an outage on the LAN. The softswitch 30 polls the relevant network agent (or agents) by sending a message such as a SIP OPTIONS message (RFC 3621, §11) to which the network agent would respond. The OPTIONS message is suitable for this purpose as it will not commence a SIP session and therefore has minimum impact on the network.

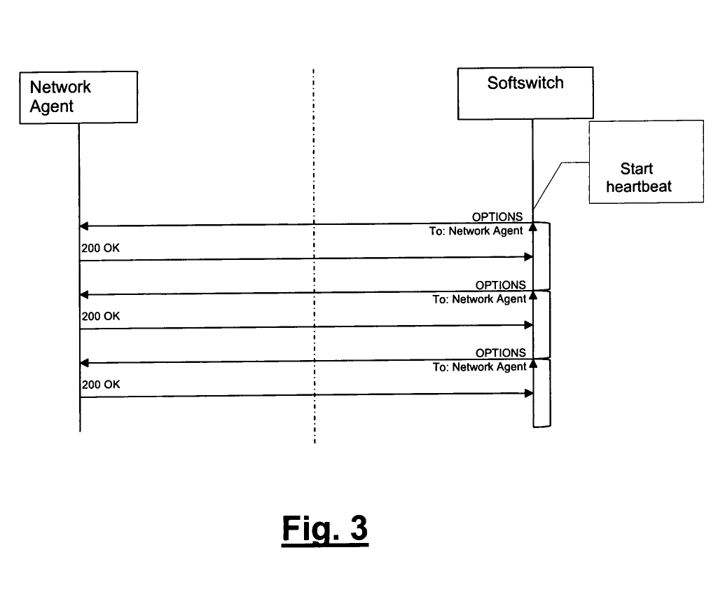

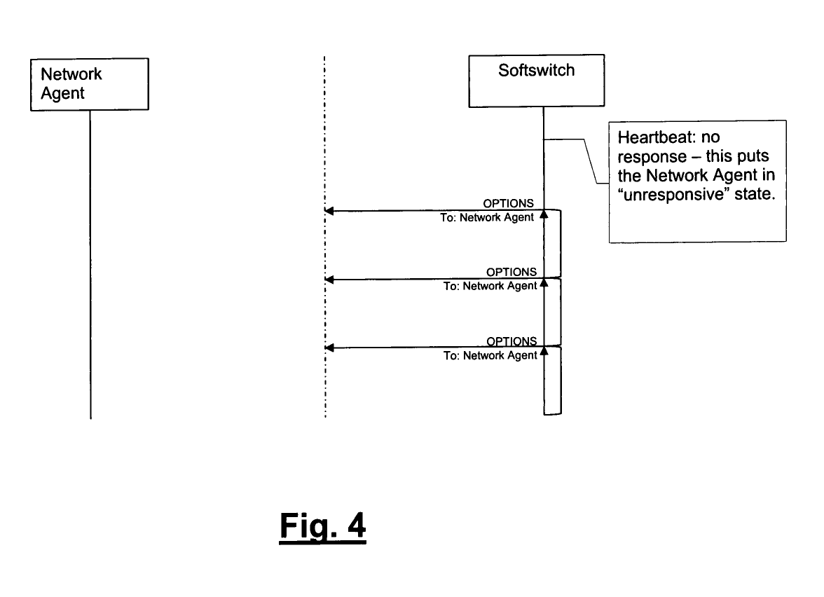

The network agent is assumed to be functional and, should there be no response from the network agent, the LAN is then deemed not accessible. Call flow diagrams illustrating acknowledgment responses (“200 OK”) and non-responses to polling of the network agents (“heartbeat”), respectively, are provided in FIGS. 3 and 4. The polling of network agents may occur as needed, on demand, or on a scheduled basis, i.e., at periodic intervals.

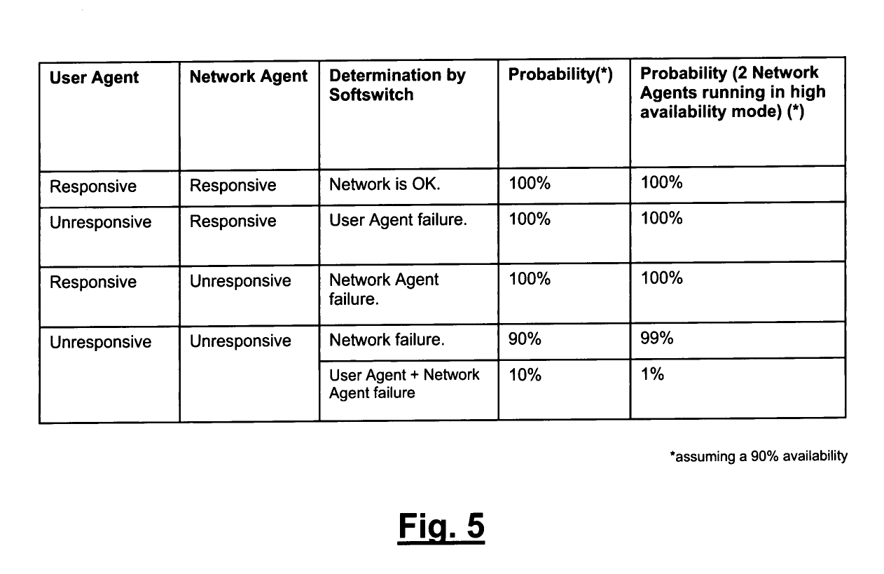

A network agent may also fail and in that event the switch would lose the ability to test the availability of the network independently of the endpoints or user agents. To increase the availability of the network status determination system (“a high-availability mode”), at least one additional or backup network agent can be provided as illustrated in LAN 2 of FIG. 1. In this configuration, LAN 2 has two network agents associated with each other—NA 2a 52 and NA 2b 54, where initially network agent NA 2a is active and NA 2b is on standby. Should NA 2a fail, network agent NA 2b would then shift to the “active” mode and respond to messages. A protocol suitable for performing the handoff from one network agent to another is the Virtual Router Redundancy Protocol (VRRP), described in RFC 3768, incorporated here by reference. If desired, more than two network agents could be deployed to increase the ability to respond. The probabilities set forth in the table in FIG. 5 assume a 90% availability rate for the network agents.

Any device that will respond to a SIP OPTIONS message may serve as the network agent, such as a SIP gateway or a proxy. Also, the method and apparatus is not limited to SIP. Any protocol that enables polling of an endpoint in a subnet in the same fashion as SIP, such as MGCP and H.323, may be utilized. Additionally, the protocol can be one native to the network controller, softswitch, or registrar, and its user agents.

The system may also be configured to send inquiry messages to user agents in addition to the messages directed to network agents. For example, in a continuously-polled system, the network controller or switch could alternately query the user and network agents.

What is claimed is:

1. A system, comprising:
a network;
at least one user agent located on the network;
a network controller, the controller comprising means for generating a status inquiry message; and
at least one network agent located on the network, the network agent comprising means responsive to a status inquiry message.

2. A system as set forth in claim 1, where the network comprises a plurality of subnets.

3. A system as set forth in claim 2, further comprising
at least one backup network agent, where the backup network agent is located on a subnet having another network agent and is associated with the other network agent; and
in the event of a failure of one of the network agents on the subnet, means for placing the other network agent in the active mode.

4. A system as set forth in claim 1, where the user agents comprise means responsive to a status inquiry message.

5. A system as set forth in claim 1, where the status inquiry message comprises a SIP OPTIONS message.

6. A system as set forth in claim 1, where the status inquiry message comprises a protocol native to the network controller and the user agents.

7. A system as set forth in claim 1, where the network controller comprises means for generating a status inquiry message at periodic intervals.

8. A method for determining the status of a network comprising a network controller and user agents, comprising:
placing at least one network agent on the network;
sending a status inquiry message to at least one network agent; and
evaluating the response to the status inquiry message.

9. A method as set forth in claim 8, where the step of placing at least one network agent on the network comprises placing the network agent on a subnet of the network.

10. A method as set forth in claim 9, where the step of placing at least one network agent on the network comprises
locating at least one backup network agent on a subnet having another network agent;
in the event of a failure of one of the network agents on the subnet, placing the other network agent in the active mode.

11. A method as set forth in claim 8, further comprising sending a status inquiry message to at least one user agent and evaluating the response to the status inquiry message.

12. A method as set forth in claim 8, where the step of sending a status inquiry message to at least one network agent comprises sending a SIP OPTIONS message.

13. A method as set forth in claim 8, where the step of sending a status inquiry message to at least one network agent comprises sending a status inquiry message in a protocol native to the network controller and the user agents.

14. A method as set forth in claim 8, where the step of sending a status inquiry message to at least one network agent comprises polling the network agent at periodic intervals.
